(19) United States
(12) Patent Application Publication
(10) Pub. No.: US 2016/0357588 A1
(43) Pub. Date: Dec. 8, 2016

(54) QUEUE MANAGEMENT METHOD, NON-TRANSITORY COMPUTER-READABLE RECORDING MEDIUM AND QUEUE MANAGEMENT DEVICE

(71) Applicant: FUJITSU LIMITED, Kawasaki-shi (JP)

(72) Inventors: Yuhei SHIBUKAWA, Kawasaki (JP); Tomohiro Kawasaki, Yokohama (JP); Osamu Miyamoto, Shizuoka (JP)

(73) Assignee: FUJITSU LIMITED, Kawasaki-shi (JP)

(21) Appl. No.: 15/168,710

(22) Filed: May 31, 2016

(30) Foreign Application Priority Data
Jun. 4, 2015 (JP) 2015-114077

(51) Int. Cl. G06F 9/455; H04L 29/08

(52) U.S. Cl. CPC G06F 9/45558; H04L 67/10; G06F 2009/45595

(57) ABSTRACT

A queue management method including queuing, in a specific queue of a first virtual machine, one or more messages addressed to the specific queue, generating, when transferring management of the specific queue from the first virtual machine to a second virtual machine, a first queue and a second queue in the second virtual machine, queuing, in the generated first queue, the one or more messages that have been queued in the specific queue, queuing, after the second queue has been generated, a received message addressed to the specific queue in the second queue and performing, in response to an instruction to perform reference to or an operation for a specific message corresponding to the specific queue, reference to or an operation for the specific message in order of the first queue, the specific queue, and the second queue.

### CROSS-REFERENCE TO RELATED APPLICATION

This application is based upon and claims the benefit of priority of the prior Japanese Patent Application No. 2015-114077, filed on Jun. 4, 2015, the entire contents of which are incorporated herein by reference.

### FIELD

The embodiment discussed herein is related to a queue management method, a computer readable recording medium and a queue management device.

### BACKGROUND

Carriers (which will be hereinafter also referred to merely as “carriers”) that provide services to users, for example, construct business systems in accordance with applications and operate the business systems in order to provide various types of services to users.

Such a business system includes, for example, a message queue system that manages a processing execution request (a message) that is transmitted and received between a plurality of applications. Specifically, for example, the message queue system temporarily stores a message that has been transmitted by an application to another application. Thus, when each application that cooperates with the message queue system transmits and receives a message, synchronization between applications is not performed. Therefore, the message queue system may increase processing efficiency of each application that transmits and receives a message (see, for example, Japanese National Publication of International Patent No. 2009-528620 and Japanese Laid-open Patent Publication No. 2004-326754).

### SUMMARY

According to an aspect of the invention, a queue management method including queuing, in a specific queue of a first virtual machine, one or more messages addressed to the specific queue, generating, when transferring management of the specific queue from the first virtual machine to a second virtual machine, a first queue and a second queue in the second virtual machine, queuing, in the generated first queue, the one or more messages that have been queued in the specific queue before generating the first queue, queuing, after the second queue has been generated, a received message addressed to the specific queue in the second queue and performing, in response to an instruction to perform reference to or an operation for a specific message corresponding to the specific queue, reference to or an operation for the specific message in order of the first queue, the specific queue, and the second queue.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an entire configuration of an information processing system;

FIG. 2 is a diagram illustrating an operation of the message queue system;

FIG. 3 is a diagram illustrating an operation of the message queue system;

FIG. 4 is a diagram illustrating an operation performed when queue management transfer is performed;

FIG. 5 is a diagram illustrating a hardware configuration of an information processing device;

FIG. 6 is a functional block diagram of the information processing device of FIG. 5;

FIG. 7 is a flow chart illustrating an outline of queue management processing according to a first embodiment;

FIG. 8 is a flow chart illustrating an outline of queue management processing according to the first embodiment;

FIG. 9 is a flow chart illustrating an outline of queue management processing according to the first embodiment;

FIG. 10 is a diagram illustrating an outline of queue management processing according to the first embodiment;

FIG. 11 is a diagram illustrating an outline of queue management processing according to the first embodiment;

FIG. 12 is a diagram illustrating an outline of queue management processing according to the first embodiment;

FIG. 13 is a diagram illustrating an outline of queue management processing according to the first embodiment;

FIG. 14 is a diagram illustrating an outline of queue management processing according to the first embodiment;

FIG. 15 is a flow chart illustrating details of message transfer processing according to the first embodiment;

FIG. 16 is a flow chart illustrating details of message addition processing according to the first embodiment;

FIG. 17 is a flow chart illustrating details of message reference processing according to the first embodiment;

FIG. 18 is a flow chart illustrating details of message reference processing according to the first embodiment;

FIG. 19 is a flow chart illustrating details of message reference processing according to the first embodiment;

FIG. 20 is a flow chart illustrating details of message reference processing according to the first embodiment;

FIG. 21 is a flow chart illustrating details of queue addition processing according to the first embodiment;

FIG. 22 is a flow chart illustrating details of queue deletion processing according to the first embodiment;

FIG. 23 is a table illustrating queue identification information before processing of S32 is executed;

FIG. 24 is a table illustrating queue identification information after the processing of S32 is executed;

FIG. 25 is a table illustrating state information before processing of S33 is executed;

FIG. 26 is a table illustrating state information after the processing of S33 is executed;

FIG. 27 is a table illustrating queue identification information after the processing of S36 is executed;

FIG. 28 is a table illustrating queue identification information after the processing of S37 is executed;

FIG. 29 is a table illustrating state information after the processing of S38 is executed; and

FIG. 30 is a table illustrating queue identification information after the processing of S84 is executed.

### DESCRIPTION OF EMBODIMENT

There are cases where the above-described message queue system is constructed, for example, on a virtual machine (VM) generated in a physical machine. In this case, a carrier increases and reduces the number of virtual machines on which the message queue system operates, depending on a message processing amount, the number of queues (areas in which messages are stored) that are to be managed, and the like. Thus, the carrier may efficiently use resources of the physical machine, which are used for generating a virtual machine.

In such a case, for example, when deletion of a virtual machine is performed, the carrier transfers a queue generated in the virtual machine that is to be deleted to another virtual machine. Also, for example, there are cases where, when a new virtual machine is generated, the carrier transfers a queue generated in an existing virtual machine to another virtual machine in order to reduce the processing load of the existing virtual machine.

In the above-described case, the carrier stops services that the carrier provides to users using the message queue system, and then, performs message transfer. Thus, the carrier may reduce influences of queue management transfer, that is, for example, an influence in which the processing orders of messages stored in a transfer target queue is switched, and the like.

However, depending on user's usage form of the message queue system, there are cases where it is not possible to stop a message queue service. Therefore, in this case, the carrier is not able to increase and reduce the number of virtual machines on which a message queue system is constructed.

According to an aspect, it is an object of the present disclosure to enable queue management transfer to be performed while receiving a message queue.

[Configuration of Message Queue System]

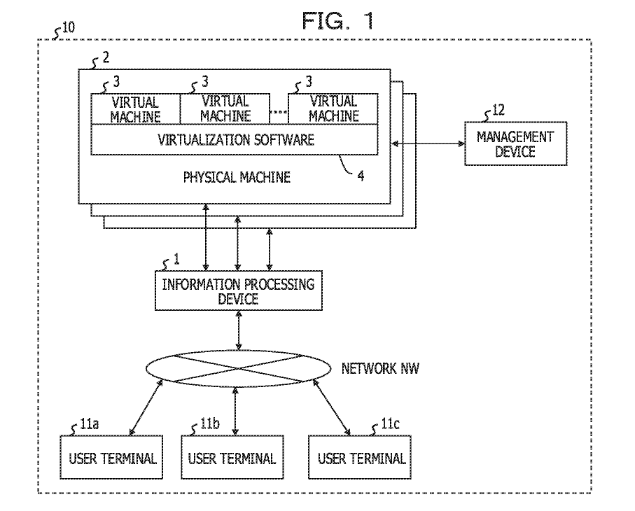

FIG. 1 is a diagram illustrating an entire configuration of a message queue system 10 (which will be hereinafter also referred to as an information processing system 10). The message queue system 10 illustrated in FIG. 1 includes an information processing device 1 (which will be hereinafter also referred to as a computer 1), a physical machine 2 on which a virtual machine 3 is generated, a user terminal 11, and a management device 12 that manages the virtual machine 3. The virtual machine 3 may be accessed from a user terminal 11a, a user terminal 11b, and a user terminal 11c (which, as a whole, will be hereinafter also referred to as the user terminal 11) via a network NW, such as the Internet, an intranet, and the like.

The physical machine 2 includes a plurality of physical machines in the example of FIG. 1, and each of the physical machines includes physical resources, such as a central processing unit (CPU), a memory, and the like. The physical resources of each of the physical machines 2 are allocated to a plurality of virtual machines 3.

The management device 12 is capable of accessing the virtual machines 3 and manages each of the virtual machines 3. Specifically, the management device 12 monitors the processing loads of the virtual machines 3. Then, for example, when there is a virtual machine 3 the processing load of which exceeds a predetermined upper limit threshold, the management device 12 generates a new virtual machine 3 in the physical machine 2. On the other hand, for example, when there is a virtual machine 3 the processing load of which is lower than a predetermined lower limit threshold, the management device 12 deletes some of the virtual machines 3 generated in the physical machine 2. Note that the management device 12 may be constructed in a different physical machine from the physical machine 2, and also may be constructed in one of the virtual machines 3 generated in the physical machine 2.

The virtual machines 3 are used, for example, for providing an infrastructure (which will be hereinafter also referred to as a cloud service) thereof to users via networks. A cloud service is a service that provides a base used for constructing and operating a computer system, that is, an infrastructure itself of the virtual machine 3, a network, or the like via the network. Also, for example, a user accesses a cloud service portal site from the user terminal 11, selects specifications, such as, for example, the clock frequency of a CPU, a memory capacity (GB), a hard disk capacity (MB/sec, IOPS), and a network communication bandwidth (Gbps), which are used in a virtual machine, and concludes a cloud user contract therefore. Also, the user terminal 11 enables, for example, monitoring of an operation state of the virtual machine 3, an operation on the virtual machine 3, and the like.

For example, a business system (which will be hereinafter also referred to merely as a business system) used for providing a service to a user is constructed in the virtual machine 3. Thus, the carrier may provide various services to users.

A virtualization software 4 is a base software that causes the virtual machines 3 to operate by allocating the physical resources of the physical machine 2 in accordance with an instruction sent from the management device 12. The virtualization software 4 operates, for example, on the physical machine 2.

The information processing device 1 manages queues (not illustrated) generated in the virtual machines 3. Then, the information processing device 1 performs an operation on a queue, based on an application programming interface (API) received from the user terminal 11. Specifically, the information processing device 1 performs generation and deletion of a queue, addition of a new message to a queue, and the like. An operation of the message queue system will be described below.

[Operation of Message Queue System]

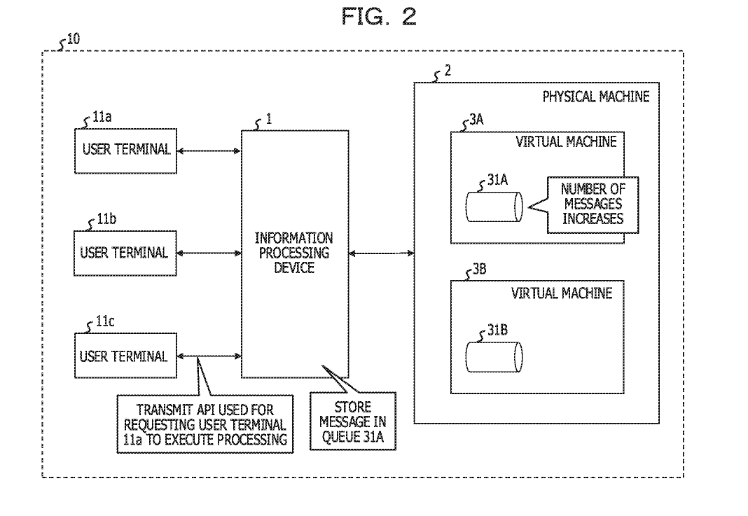

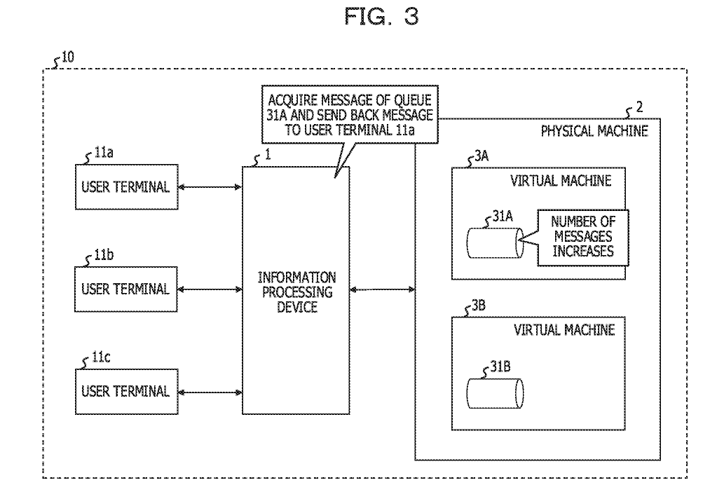

Each of FIG. 2 and FIG. 3 is a diagram illustrating an operation of the message queue system 10. In the message queue system 10 illustrated in FIG. 2 and FIG. 3, a virtual machine 3A and a virtual machine 3B are generated in the physical machine 2. Then, a queue 31A is provided in the virtual machine 3A, and a queue 31B is provided in the virtual machine 3B. Assuming that the queue 31A is a queue that stores a message with which the user terminal 11c (for example, an application that operates on the user terminal 11c) requests the user terminal 11a (for example, an application that operates on the user terminal 11a) to execute processing, the following description will be given.

Specifically, as illustrated in FIG. 2, when the information processing device 1 receives an API used for requesting the user terminal 11a to execute processing from the user terminal 11c, the information processing device 1 stores a message included in the received API in the tail end of the queue 31A. Then, as illustrated in FIG. 3, when the information processing device 1 receives an API used for acquiring a message stored in the queue 31A from the user terminal 11a, the information processing device 1 acquires a message stored in the head of the queue 31A and transmits (sends back) the message to the user terminal 11a. Then, the user terminal 11a executes processing that corresponds to the received message.

That is, in the message queue system 10 illustrated in FIG. 2 and FIG. 3, processing is performed on messages stored in the queue, starting with a message that was stored first, in the order in which the messages were stored. Thus, each of the user terminals 11 may transmit and receive a message without being synchronized with another one of the user terminals 11.

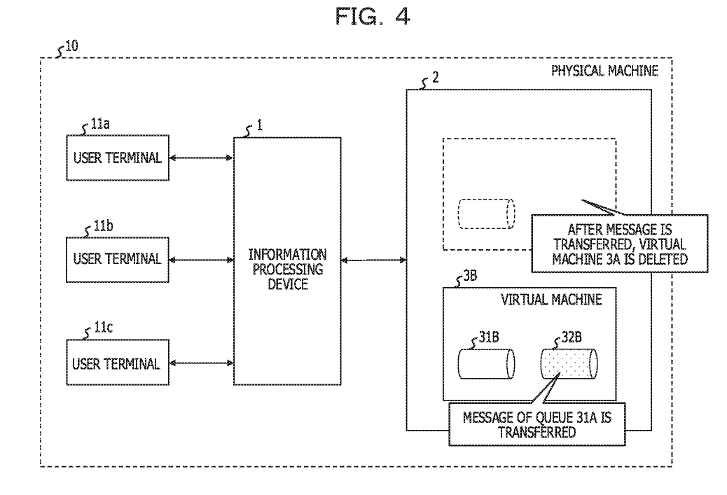

Next, an operation performed when queue management transfer is performed will be described. FIG. 4 is a diagram illustrating an operation performed when queue management transfer is performed.

In the example illustrated in FIG. 4, the information processing device 1 transfers a message included in the queue 31A of the virtual machine 3A to the queue 31B of the virtual machine 3B. Thus, for example, even when a message (a message on which processing has not been performed) remains in the queue 31A, the information processing device 1 may delete the virtual machine 3A.

In the above-described case, for example, the information processing device 1 stops providing the service to the user, and then, transfers a message included in a queue. Thus, the information processing device 1 may reduce influences thereof on the processing order for messages included in a transfer target queue, and the like.

However, depending on user's usage form of the message queue system 10, there are cases where it is not possible to stop a message queue service. Therefore, there are cases where the carrier is not able to increase and reduce the number of the virtual machines 3 in which the message queue system 10 is constructed.

In view of the forgoing, in this embodiment, when management of a specific queue is transferred from the first virtual machine to the second virtual machine, the information processing device 1 generates a first queue and a second queue. Thereafter, the information processing device 1 transfers messages included in the specific queue to the first queue in order, starting with a head message. Also, the information processing device 1 stores a message for the specific queue in the second queue. Then, in accordance with instruction of reference to or an operation for a message, the information processing device 1 refers to or operates messages in the order of the first queue, the specific queue, and the second queue.

That is, the information processing device 1 stores a message generated while messages included in the specific queue are transferred in the second queue that is a different queue from the specific queue for which message transfer is performed and the first queue. Therefore, the information processing device 1 may manage messages such that a message that was stored in the specific queue before queue management transfer is started and a message that was generated while queue management transfer is performed are separated from each other.

Thus, the information processing device 1 may perform transfer of management of a specific queue without stopping services to reduce influences thereof on the message processing order and the like.

[Hardware Configuration of Information Processing Device]

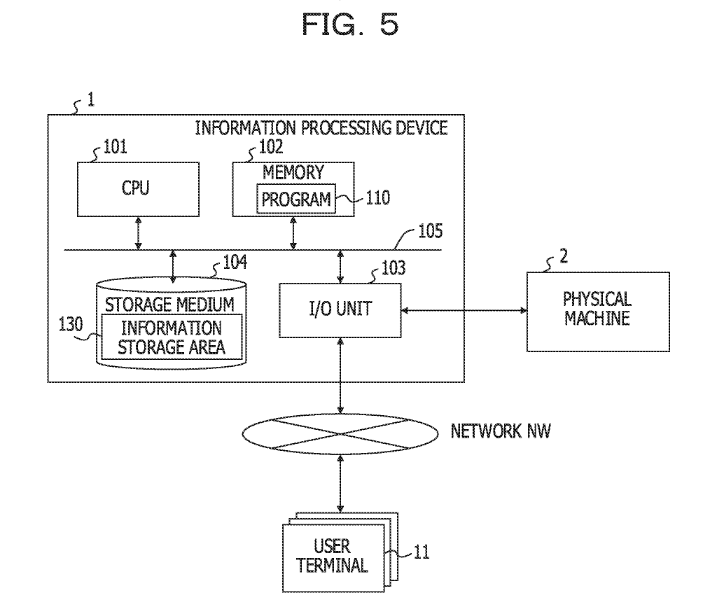

Next, a hardware configuration of the information processing device 1 will be described. FIG. 5 is a diagram illustrating a hardware configuration of the information processing device 1.

The information processing device 1 includes a CPU 101 that is a processor, a memory 102, an external interface (I/O unit) 103, and a storage medium (storage) 104. The above-described components are coupled to one another via a bus 105.

The storage medium 104 stores a program 110 used for performing processing (which will be hereinafter also referred to as queue management processing) of managing queues generated in the virtual machines 3 on a program storage area (not illustrated) in the storage medium 104.

As illustrated in FIG. 5, in executing the program 110, the CPU 101 loads the program 110 from the storage medium 104 to the memory 102 and performs queue management processing in cooperation with the program 110.

The storage medium 104 includes an information storage area 130 (which will be hereinafter also referred to as a storage section 130) that stores, for example, information used when queue management processing is performed.

The external interface 103 performs communication with the physical machine 2 (the virtual machines 3 generated in the physical machine 2). Also, the external interface 103 performs communication with the user terminal 11 via the network NW.

[Software Configuration of Information Processing Device]

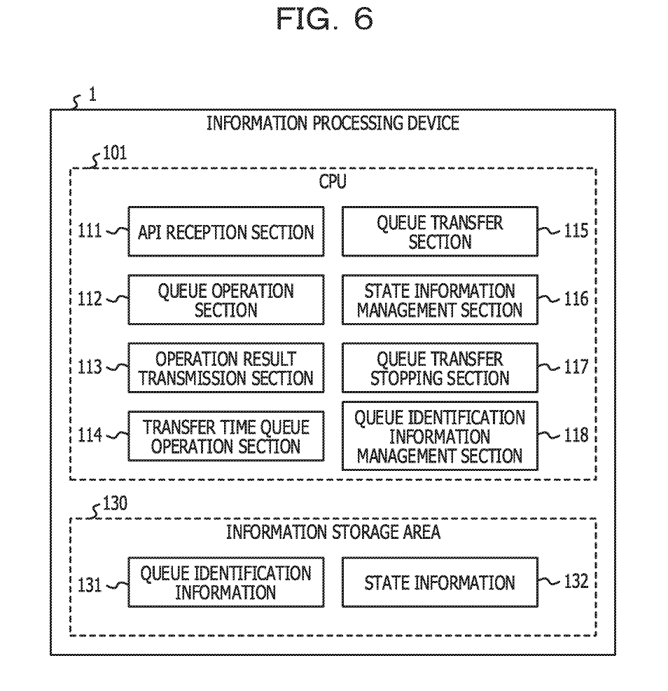

Next, a software configuration of the information processing device 1 will be described. FIG. 6 is a functional block diagram of the information processing device 1 of FIG. 5. The CPU 101 cooperates with the program 110 to operate as an API reception section 111, a queue operation section 112, an operation result transmission section 113, and a transfer time queue operation section 114 (which will be hereinafter also referred to merely as a queue operation section 114 or a queue generation section 114). Also, the CPU 101 cooperates with the program 110 to operate as a queue transfer section 115, a state information management section 116, a queue transfer stopping section 117, and a queue identification information management section 118. Furthermore, a queue identification information 131 (which will be hereinafter also referred to merely as identification information 131) and state information 132 are stored in the information storage area 130.

The API reception section 111 receives, for example, an API transmitted by the user via the user terminal 11. The API is used for instructing the information processing device 1 to perform, for example, addition of a message to a queue generated in the virtual machines 3 and reference to and an operation (including acquiring a message in order to process the message) for a message stored in a queue generated in the virtual machines 3. The API is used for instructing the information processing device 1 to perform, for example, generation of a new queue in the virtual machines 3 and deletion of a queue that has been already generated in the virtual machines 3.

For example, when the API reception section 111 receives an API used for adding a message, the queue operation section 112 stores a message (which will be hereinafter also referred to as a received message) included in the received API. Specifically, in this case, the queue operation section 112 specifies, among the plurality of virtual machines 3 each of which manages queues, a queue corresponding to the queue identification information 131 included in the received message, based on the queue identification information 131 included in the received message. Then, the queue operation section 112 stores the received message in the specified queue. Note that the queue identification information 131 is information used for identifying each queue generated in the virtual machines 3. Then, the queue identification information 131 that may be possibly included in the received message may be stored, for example, in the information storage area 130 in advance.

Also, for example, when the API reception section 111 receives an API used for performing reference to or an operation for a message, the queue operation section 112 performs reference to or an operation for a message indicated by information included in the received API. Furthermore, for example, when the API reception section 111 receives an API used for generating a queue, the queue operation section 112 generates a new queue. Also, for example, when the API reception section 111 receives an API used for deleting a queue, the queue operation section 112 deletes a deletion target queue.

The operation result transmission section 113 transmits a result of an operation or the like that has been performed by the queue operation section 112. Specifically, the operation result transmission section 113 transmits a result of an operation that has been performed in accordance with information included in an API and a message that has been acquired, based on contents included in the API, to the user terminal 11 that has transmitted the API.

For example, while transfer of management of queues generated in the virtual machines 3 is performed, the transfer time queue operation section 114, instead of the queue operation section 112, performs an operation of a queue and the like.

Also, for example, the queue transfer section 115 performs queue management transfer. For example, the queue transfer section 115 transfers messages stored in the queue.

Specifically, when transfer of management of a specific queue that is managed by one of the virtual machines 3 (which will be hereinafter also referred to as a first virtual machine 3A) and corresponds to the specific queue identification information 131 to another one of the virtual machines 3 (which will be hereinafter also referred to as a second virtual machine 3B) is performed, the transfer time queue operation section 114 generates a first queue and a second queue in the second virtual machine. Then, the queue transfer section 115 stores a specific message that is stored in the specific queue in the first queue from a head side of the specific queue.

When, while the queue transfer section 115 transfers management of the specific queue, the API reception section 111 receives an API used for adding a message including the queue identification information 131 that corresponds to the specific queue, the transfer time queue operation section 114 stores a received message in the second queue.

Furthermore, when, while the queue transfer section 115 transfers management of the specific queue, the API reception section 111 receives an API used for instructing to perform reference to or an operation for a message, the transfer time queue operation section 114 performs reference to or an operation for a message in the order of the first queue, the specific queue, and the second queue.

Also, for example, after queue management transfer performed by the queue transfer section 115 is completed, the transfer time queue operation section 114 deletes the specific queue and the second queue. A specific example of generation and deletion of a queue performed by the transfer time queue operation section 114 will be described later. Also, a specific example of queue management transfer performed by the queue transfer section 115 will be described later.

Note that, assuming that, for example, when the state information 132 indicates that queue management transfer is not being performed, the queue operation section 112 operates, the following description will be given. Also, assuming that, for example, when the state information 132 indicates that queue management transfer is being performed, the transfer time queue operation section 114 operates, the following description will be given.

The state information management section 116 updates the state information 132. The state information 132 includes information indicating whether or not queue management transfer is being performed by the queue transfer section 115. A specific example of the state information 132 will be described later.

When, while queue management transfer is performed by the queue transfer section 115, the API reception section 111 receives an API used for instructing to perform reference to or an operation for a message, the queue transfer stopping section 117 stops (discontinues) queue management transfer performed by the queue transfer section 115. A specific example in which the queue transfer stopping section 117 stops queue management transfer will be described later.

The queue identification information management section 118 manages the queue identification information 131. Specifically, for example, in accordance with generation or deletion of a queue, which has been performed by the queue operation section 112, the queue identification information management section 118 adds or deletes information related to the queue, which has been generated or deleted, among pieces of information included in the queue identification information 131.

Note that, although a case where the above-described components operate in the same information processing device 1 will be described below, the above-described components may operate in different information processing devices 1 from one another. Also, when, while the queue transfer section 115 transfers management of a specific queue, an API used for adding a message including the queue identification information 131 that corresponds to the specific queue is generated, the queue transfer section 115, instead of the transfer time queue operation section 114, may store a received message in the second queue.

### OUTLINE OF FIRST EMBODIMENT

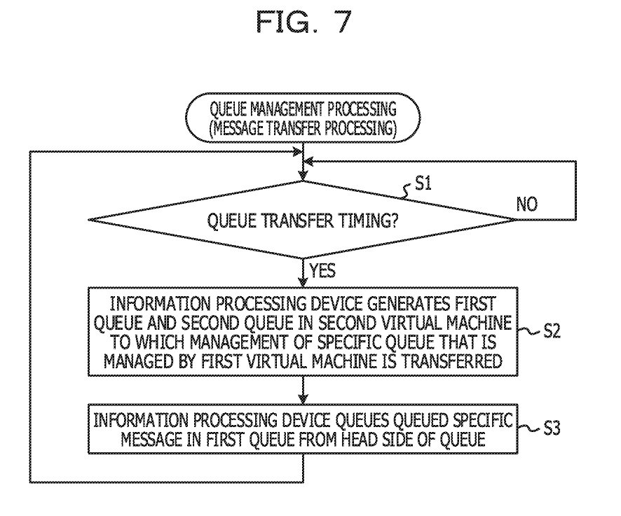

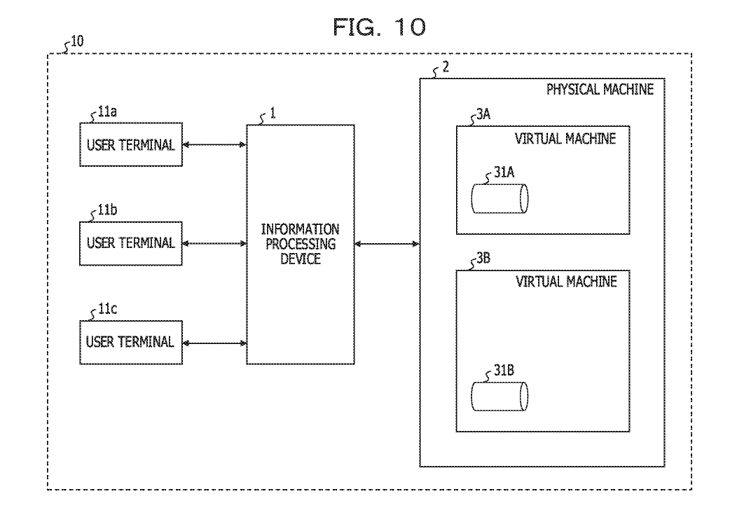

Next, an outline of the first embodiment will be described. Each of FIG. 7 to FIG. 9 is a flow chart illustrating an outline of queue management processing according to the first embodiment. Also, each of FIG. 10 to FIG. 14 is a diagram illustrating an outline of queue management processing according to the first embodiment. With reference to FIG. 10 to FIG. 14, the queue management processing of FIG. 7 to FIG. 9 will be described.

[Outline of Message Transfer Processing]

First, processing (which will be also referred to as message transfer processing) of performing message transfer in queue management processing according to the first embodiment will be described. FIG. 7 is a flow chart illustrating an outline of message transfer processing according to the first embodiment.

As illustrated in FIG. 7, the information processing device 1 stands by until a queue transfer timing (NO in S1). The queue transfer timing may be, for example, a timing at which a desire of transfer of a specific queue that is managed by the first virtual machine 3A to the second virtual machine 3B arises due to exceeding of the loads of the virtual machines 3 that manage queues over a predetermined threshold. Also, the queue transfer timing may be, for example, a timing at which a desire of transfer of a specific queue to the second virtual machine 3B arises before the first virtual machine 3A that manages the specific queue is deleted.

Thereafter, if a queue transfer timing arises (YES in S1), the information processing device 1 generates a first queue and a second queue in the second virtual machine 3B to which management of the specific queue that is managed by the first virtual machine 3A is transferred (S2). A specific example of an outline of processing of S2 will be described below.

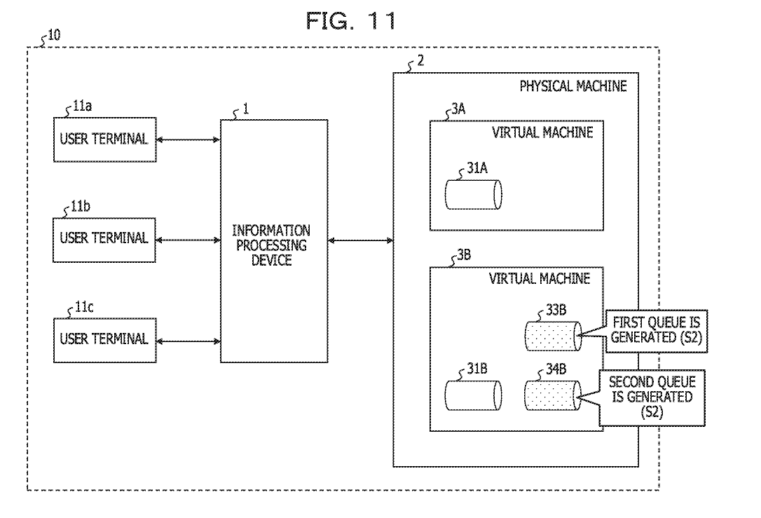

Each of FIG. 10 and FIG. 11 is a diagram illustrating a specific example of an outline of the processing of S2. FIG. 10 is a diagram illustrating the message queue system 10 before the processing of S2 is performed. In the message queue system 10 illustrated in FIG. 10, the virtual machine 3A and the virtual machine 3B are generated in the physical machine 2. A queue 31A is generated in the virtual machine 3A, and a queue 31B is generated in the virtual machine 3B.

FIG. 11 is a diagram illustrating the message queue system 10 after the processing of S2 is performed. As illustrated in FIG. 11, before transfer of a message stored in the queue 31A is performed, the information processing device 1 generates a first queue 33B and a second queue 34B in the virtual machine 3B, which is a virtual machine that is a transfer destination of a message (S2). Thus, the information processing device 1 may manage messages such that messages received before transfer of management of the queue 31A is performed and messages received while transfer of management of the queue 31A is performed are separated from each other.

Returning to FIG. 7, the information processing device 1 stores, in the first queue, specific messages that have been stored in the specific queue in order, starting with a message stored in a head side of the queue (S3). A specific example of an outline of processing of S3 will be described below.

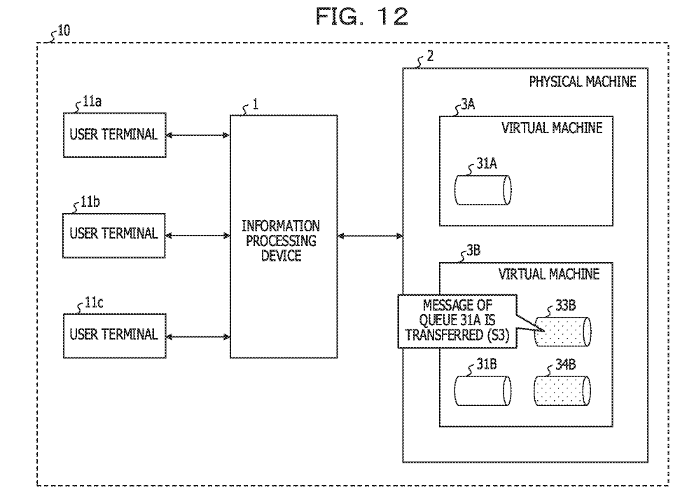

FIG. 12 is a diagram illustrating a specific example of an outline of the processing of S3. Specifically, FIG. 12 is a diagram illustrating the message queue system 10 after the processing of S3 is performed. As illustrated in FIG. 12, the information processing device 1 transfers messages stored in the queue 31A only to the first queue 33B among queues generated in S2. In this case, the information processing device 1 stores messages stored in the queue 31A in the first queue 33B in the order in which the messages were stored in the queue 31A (in an ascending order in terms of processing order). Thus, the information processing device 1 may maintain information related to the order of storing messages in the queue 31A even after messages are transferred to the first queue 33B.

[Outline of Message Addition Processing]

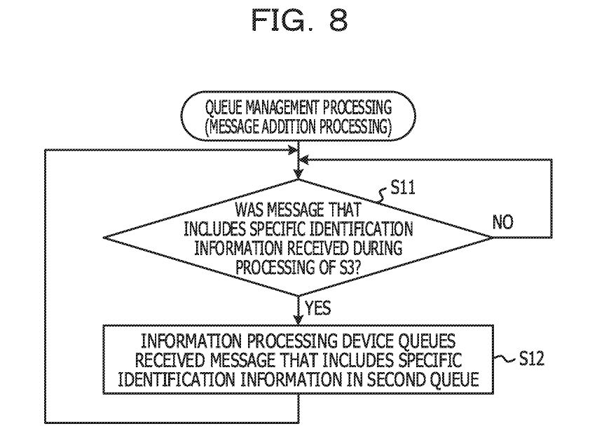

Next, processing (which will be hereinafter also referred to as message addition processing) of adding a message in queue management processing according to the first embodiment will be described. FIG. 8 is a flow chart illustrating an outline of message addition processing according to the first embodiment.

As illustrated in FIG. 8, while the processing of S3 illustrated in FIG. 7 is performed, the information processing device 1 stands by until the information processing device 1 receives a message including the specific queue identification information 131 (NO in S11). Then, if a message including the specific queue identification information 131 is received (YES in S11), the information processing device 1 stores the received message including the specific queue identification information 131 in the second queue (S12).

That is, when, while management of the specific queue is transferred, a message that is to be added to the specific queue is received, the information processing device 1 stores the received message not in the specific queue but in the second queue. Thus, the information processing device 1 may manage messages such that messages generated before management of the specific queue is transferred and messages generated while management of the specific queue is transferred are separated from each other. Therefore, the information processing device 1 may reduce influences of transfer of management of the specific queue on the message processing order. A specific example of an outline of processing of S12 will be described below.

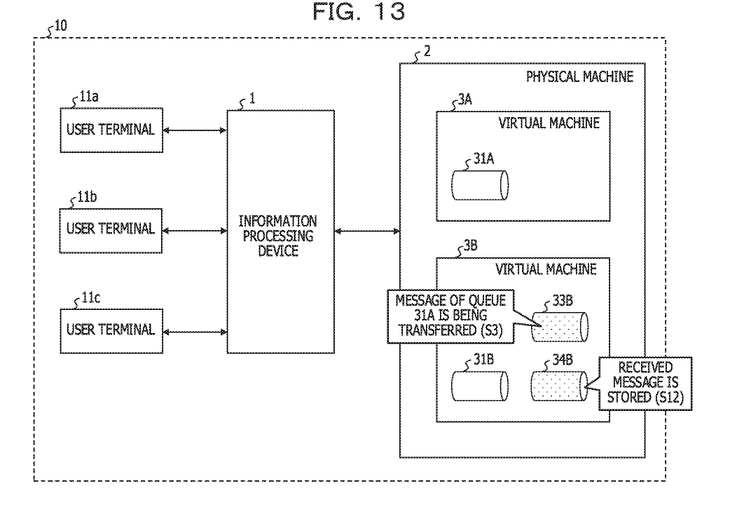

FIG. 13 is a diagram illustrating a specific example of an outline of the processing of S12. Specifically, FIG. 13 is a diagram illustrating the message queue system 10 after the processing of S12 is performed. As illustrated in FIG. 13, when, while messages included in the queue 31A are transferred to the first queue 33B, a message for the queue 31A is received, the information processing device 1 stores the received message in the second queue 34B. Thus, the information processing device 1 may store messages generated before management of the queue 31A is transferred in the first queue 33B, and messages generated while management of the queue 31A is transferred in the second queue 34B.

[Outline of Message Reference Processing]

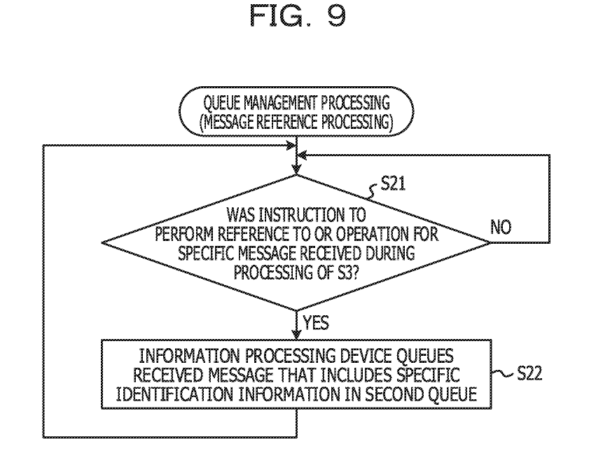

Next, processing (which will be hereinafter also referred to as message reference processing) of performing reference to or an operation for a message in queue management processing according to the first embodiment will be described. FIG. 9 is a flow chart illustrating an outline of message reference processing according to the first embodiment.

As illustrated in FIG. 9, while the processing of S3 illustrated in FIG. 7 is performed, the information processing device 1 stands by until the information processing device 1 receives an instruction to perform reference to or an operation for a specific message stored in a specific queue (NO in S21). Then, if the information processing device 1 receives an instruction to perform reference to or an operation for a specific message stored in a specific queue (YES in S21), the information processing device 1 performs reference to or an operation for the specific message in the order of the first queue, the specific queue, and the second queue (S22).

That is, while the processing of S3 is executed, the specific message is stored in one of the first queue (a transfer destination queue) and the specific queue (a transfer source queue). Then, in the processing of S3, the information processing device 1 performs transfer in order, starting with the specific message that was stored first in the specific queue. Furthermore, while the processing of S3 is executed, a message generated while messages stored in the specific queue are transferred is stored in the second queue. Therefore, while the processing of S3 is executed, a message stored in the first queue, a message stored in the specific queue, and a message stored in the second queue have a relationship in which the respective processing orders thereof are consecutive.

Therefore, in processing of S22, the information processing device 1 performs reference to or an operation for a specific message in the order of the first queue, the specific queue, and the second queue, and thus, may perform similar processing to that when transfer of the specific message is not performed. A specific example of the outline of the processing of S22 will be described below.

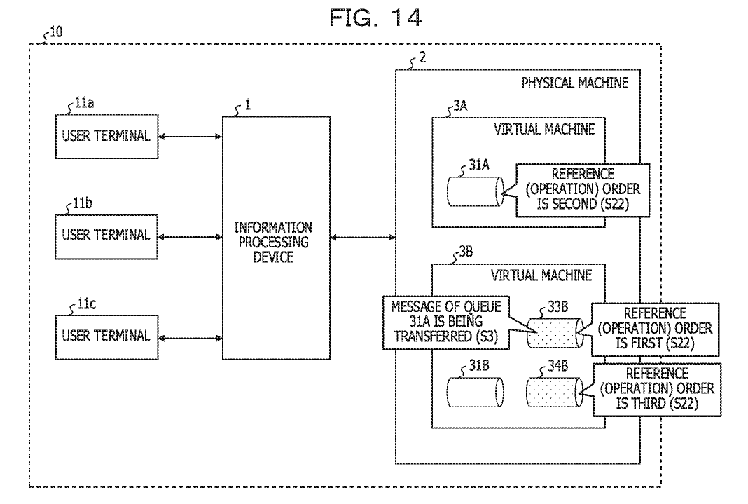

FIG. 14 is a diagram illustrating a specific example of an outline of processing of S32. Specifically, FIG. 14 is a diagram illustrating the message queue system 10 after the processing of S22 is performed. As illustrated in FIG. 14, when, while a message included in the queue 31A is transferred to the first queue 33B, the information processing device 1 performs reference to or an operation for a transfer target message, the information processing device 1 first performs reference to or an operation for the message included in the first queue 33B. Next, in this case, the information processing device 1 performs reference to or an operation for a message included in the queue 31A that is a transfer source of the transfer target message, and then, performs reference to or an operation for a message included in the second queue.

Thus, the information processing device 1 may perform queue management transfer between the virtual machine 3A and the virtual machine 3B without causing the user to be aware of the queue management transfer.

Thus, when the information processing device 1 transfers management of the specific queue 31A that is managed by the first virtual machine 3A and corresponds to the specific queue identification information 131 to the second virtual machine 3B, the information processing device 1 generates the first queue 33B and the second queue 34B in the second virtual machine 3B. Then, the information processing device 1 stores a specific message that has been stored in the specific queue 31A of the first virtual machine 3A in the first queue 33B from the head side of the queue, and stores a received message including the specific queue identification information 131 in the second queue 34B.

Thereafter, in accordance with an instruction to perform reference to or an operation for a specific message, the information processing device 1 performs reference to or an operation for the specific message in the order of the first queue 33B, the specific queue 31A, and the second queue 34B.

Thus, the information processing device 1 may perform transfer of management of the specific queue 31A without stopping services provided using the message queue system 10.

### DETAILS OF FIRST EMBODIMENT

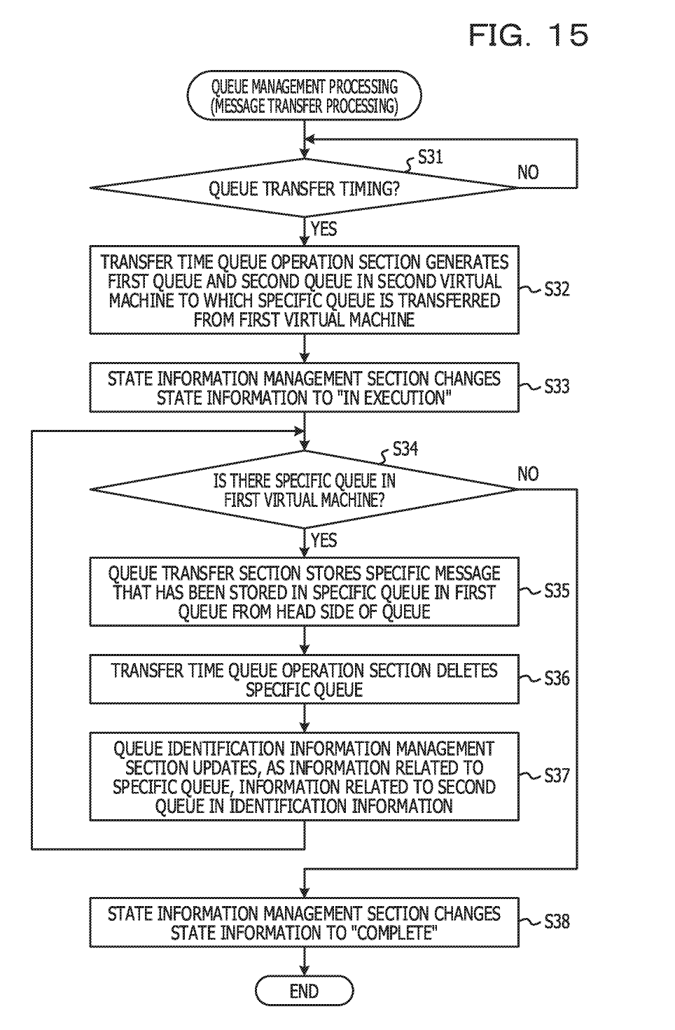

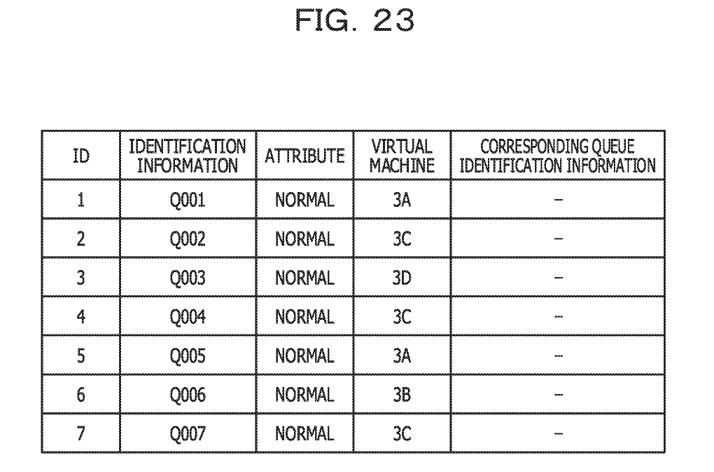

Next, details of the first embodiment will be described. Each of FIG. 15 to FIG. 22 is a flow chart illustrating details of queue management processing according to the first embodiment. Also, each of the FIG. 23 to FIG. 30 is a table illustrating details of queue management processing according to the first embodiment. With reference to FIG. 23 to FIG. 30, queue management processing of FIG. 15 to FIG. 22 will be described. Note that, assuming that a virtual machine 3A, a virtual machine 3B, a virtual machine 3C, and a virtual machine 3D are generated in the physical machine 2 illustrated in FIG. 1, the following description will be given.

[Details of Message Transfer Processing]

First, details of message transfer processing will be described. FIG. 15 is a flow chart illustrating details of message transfer processing according to the first embodiment.

As illustrated in FIG. 15, the transfer time queue operation section 114 of the information processing device 1 stands by until a queue transfer timing (NO in S31). Thereafter, if a queue transfer timing arises (YES in S31), the transfer time queue operation section 114 generates the first queue 33B and the second queue 34B in the second virtual machine 3B to which management of the specific queue 31A that is managed by the first virtual machine 3A is transferred (S32). Thus, the transfer time queue operation section 114 may perform management such that messages received before management of the queue 31A is transferred and messages received while management of the queue 31A is transferred are separated from each other.

Then, in this case, for example, as the first queue 33B and the second queue 34B are generated, the queue identification information management section 118 of the information processing device 1 updates the queue identification information 131. A specific example of the queue identification information 131 will be described below.

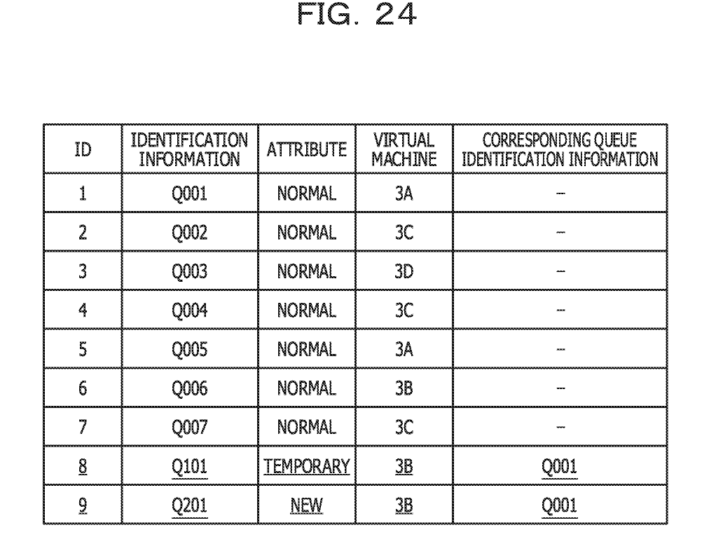

Each of FIG. 23 and FIG. 24 is a table illustrating the queue identification information 131. Specifically, FIG. 23 is a table illustrating the queue identification information 131 before processing of S32 is executed. FIG. 24 is a table illustrating the queue identification information 131 after the processing of S32 is executed.

The queue identification information 131 illustrated in FIG. 23 includes, as items, “ID”, which identifies each information included in the queue identification information 131, “IDENTIFICATION INFORMATION”, which identifies a queue generated in each of the virtual machines 3, and “ATTRIBUTE”, which indicates the attribute of each queue. In “IDENTIFICATION INFORMATION”, the same information as the queue identification information 131 included in a message that is received by the API reception section 111 is set. In “ATTRIBUTE”, “NORMAL”, which indicates a normal queue, and “TEMPORARY”, which indicates a queue that is temporarily generated when message transfer is performed, are set. Also, in “ATTRIBUTE”, “NEW”, which indicates a queue that is a message transfer destination when message transfer is performed is set.

Note that a queue (a queue that corresponds to the queue 31A in FIG. 11 and the like) for which “NORMAL” is set in “ATTRIBUTE” will be hereinafter also referred to as a normal queue. Also, a queue (a queue that corresponds to the first queue 33B in FIG. 11 and the like) for which “TEMPORARY” is set in “ATTRIBUTE” will be hereinafter also referred to as a temporary queue, and a queue (a queue that corresponds to the second queue 34B in FIG. 11 and the like) for which “NEW” is set in “ATTRIBUTE” will be hereinafter also referred to as a new queue.

Furthermore, the queue identification information 131 illustrated in FIG. 23 includes, as items, “VIRTUAL MACHINE”, which identifies the virtual machine 3 in which each queue is generated, and “CORRESPONDING QUEUE IDENTIFICATION INFORMATION” used for setting “IDENTIFICATION INFORMATION” of a corresponding normal queue when “TEMPORARY” or “NEW” is set in “ATTRIBUTE”.

Specifically, in the queue identification information 131 illustrated in FIG. 23, for information “ID” of which is “1”, “Q001” is set as “IDENTIFICATION INFORMATION”, “NORMAL” is set in “ATTRIBUTE”, and “3A”, which indicates the virtual machine 3A, is set in “VIRTUAL MACHINE”. Also, in the queue identification information 131 illustrated in FIG. 23, for information “ID” of which is “1”, a blank is set as “CORRESPONDING QUEUE IDENTIFICATION INFORMATION”. That is, the information “ID” of which is “1” is information related to a normal queue, and therefore, in “CORRESPONDING QUEUE IDENTIFICATION INFORMATION” of the information “ID” of which is “1”, a blank is set. For other information in FIG. 23, the description thereof will be omitted.

Next, the queue identification information 131 after the processing of S32 is executed will be described. As compared to the queue identification information 131 illustrated in FIG. 23, pieces of information “ID” of which is “8” and “9” are added to the queue identification information 131 illustrated in FIG. 24 (underlined parts in FIG. 24). That is, the information “ID” of which is “8” and the information “ID” of which is “9” are information for a temporary queue and information for a new queue, each of which corresponds to a normal queue “IDENTIFICATION INFORMATION” of which is “Q001”. Note that a case where management of a queue “ID” of which is “1” in the queue identification information 131 of FIG. 23 is transferred from the virtual machine 3A to the virtual machine 3B will be described below.

Specifically, in the queue identification information 131 illustrated in FIG. 24, for the information “ID” of which is “8”, “Q101” is set as “IDENTIFICATION INFORMATION”, “TEMPORARY” is set in “ATTRIBUTE”, and “3B”, which indicates the virtual machine 3B, is set in “VIRTUAL MACHINE”. Also, in the queue identification information 131 illustrated in FIG. 24, for the information “ID” of which is “8”, “Q001” is set as “CORRESPONDING QUEUE IDENTIFICATION INFORMATION”. Then, in the queue identification information 131 illustrated in FIG. 24, for the information “ID” of which is “9”, “Q201” is set as “IDENTIFICATION INFORMATION”, “NEW” is set in “ATTRIBUTE”, and “3B” is set in “VIRTUAL MACHINE”. Also, in the queue identification information 131 illustrated in FIG. 24, for the information “ID” of which is “8”, “Q001” is set as “CORRESPONDING QUEUE IDENTIFICATION INFORMATION”.

Returning to FIG. 15, the state information management section 116 of the information processing device 1 changes the state information 132 stored in the information storage area 130 to “IN EXECUTION” (S33). A specific example of the state information 132 will be described below.

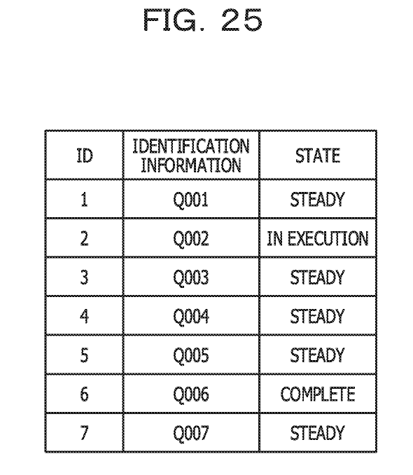

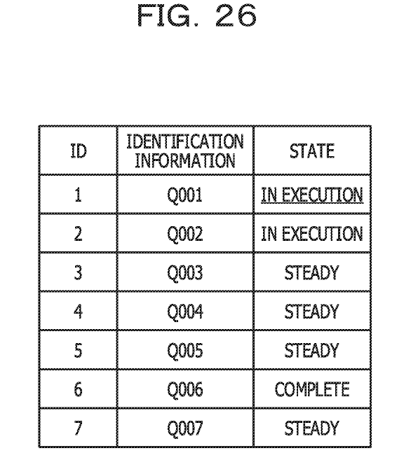

Each of FIG. 25 and FIG. 26 is a table illustrating a specific example of the state information 132. Specifically, FIG. 25 is a table illustrating the state information 132 before processing of S33 is executed. Also, FIG. 26 is a table illustrating the state information 132 after the processing of S33 is executed.

The state information 132 illustrated in FIG. 25 includes, as items, “ID”, which identifies each information included in the state information 132, “IDENTIFICATION INFORMATION”, which identifies a queue generated in each of the virtual machines 3, and “STATE”, which indicates the state of each queue. In “STATE”, for example, “STEADY”, which indicates a state in which a corresponding queue is not being moved, “IN EXECUTION”, which indicates a state in which a corresponding queue is being moved, or “COMPLETE”, which indicates that move of a corresponding queue is completed, is set.

Specifically, in the state information 132 illustrated in FIG. 25, for information “ID” of which is “1”, “Q001” is set as “IDENTIFICATION INFORMATION”, and “STEADY” is set as “STATE”. Also, in the state information 132 illustrated in FIG. 25, for information “ID” of which is “2”, “Q002” is set as “IDENTIFICATION INFORMATION”, “IN EXECUTION” is set as “STATE”. For other information in FIG. 25, the description thereof will be omitted.

Next, the state information 132 after the processing of S33 is executed will be described. As compared to the state information 132 illustrated in FIG. 25, in the state information 132 illustrated in FIG. 26, “STATE” of information “ID” of which is “1” is updated from “STEADY” to “IN EXECUTION” (an underlined part in FIG. 26). That is, before a message stored in the specific queue 31A is transferred to the first queue 33B, the state information management section 116 updates “STATE” of information that corresponds to the specific queue 31A from “STEADY” to “IN EXECUTION”.

Returning to FIG. 15, the queue transfer section 115 of the information processing device 1 stores a specific message that has been stored in the specific queue 34A in the first queue in order, starting with a message stored in a head side of the queue (YES in S34, S35). Thus, even after message transfer to the first queue 33B is performed, the queue transfer section 115 may maintain information related to the order of storing messages performed on the specific queue 31A.

Thereafter, the transfer time queue operation section 114 deletes the specific queue 31A (S36). Then, in this case, for example, the queue identification information management section 118 of the information processing device 1 updates information associated with deletion of the specific queue 31A, among pieces of information included in the queue identification information 131. The queue identification information 131 after processing of S36 is executed will be described below.

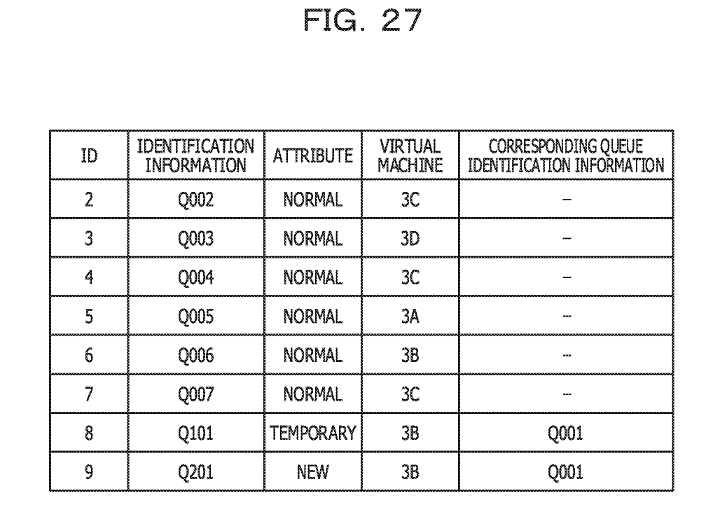

FIG. 27 is a table illustrating the queue identification information 131 after the processing of S36 is executed. As compared to the queue identification information 131 illustrated in FIG. 24, in the queue identification information 131 illustrated in FIG. 27, information “ID” of which is “1” has been deleted. That is, when the processing of S36 is executed, the queue identification information management section 118 deletes the information “ID” of which is “1”, which is information that corresponds to the specific queue 31A, in the queue identification information 131.

Returning to FIG. 15, the queue identification information management section 118 of the information processing device 1 updates, as information related to the specific queue 31A, information related to the second queue 34B in the queue identification information 131 (S37). Thus, the queue identification information management section 118 may cause queue management that had been performed by the specific queue 31A, which has been deleted in S36, on the queue identification information 131 stored in the information storage area 130 to be transferred to the second queue 34B. Therefore, the second queue 34B, instead of the specific queue 31A, which has been deleted, may function as a queue “IDENTIFICATION INFORMATION” of which is “Q001”. The queue identification information 131 after processing of S37 is executed will be described below.

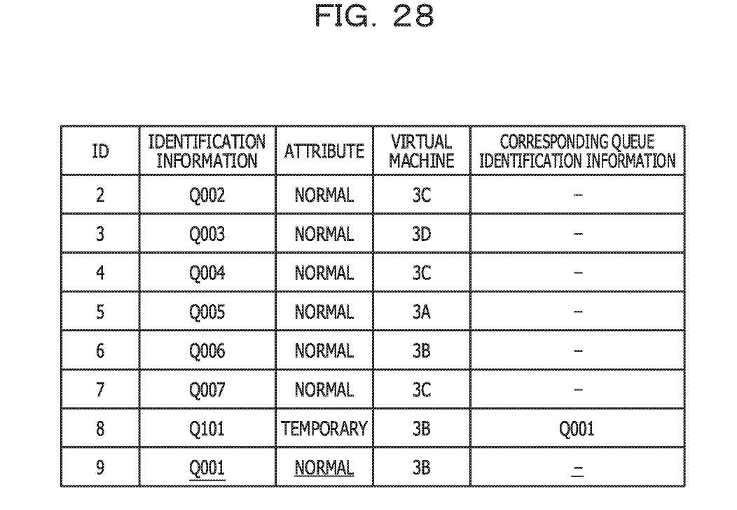

FIG. 28 is a table illustrating the queue identification information 131 after the processing of S37 is executed. As compared to the queue identification information 131 illustrated in FIG. 27, in the queue identification information 131 illustrated in FIG. 28, information “ID” of which is “9” is updated (underlined parts in FIG. 28). Specifically, in the queue identification information 131 illustrated in FIG. 28, for the information “ID” of which is “9”, “Q001” is set as “IDENTIFICATION INFORMATION”, “NORMAL” is set in “ATTRIBUTE”, and “3B” is set in “VIRTUAL MACHINE”. Also, in the queue identification information 131 illustrated in FIG. 28, for the information “ID” of which is “9”, a blank is set as “CORRESPONDING QUEUE IDENTIFICATION INFORMATION”.

Note that, in the queue identification information 131 illustrated in FIG. 28, the information “ID” of which is “8”, which is a temporary queue deleted in the processing of S37, remains. Then, there may be cases where, after the processing of S37 is completed, a message transferred from a normal queue that has been deleted in the processing of S37 is stored in the temporary queue. Therefore, when, after message transfer is completed, reference to or an operation for a new normal queue is performed, as will be described later, the information processing device 1 performs reference to or an operation for a temporary queue before performing reference to or an operation for a new normal queue. A specific example in which reference to or an operation for a temporary queue is performed after the processing of S37 is completed will be described later.

Returning to FIG. 15, the state information management section 116 changes the state information 132 stored in the information storage area 130 to “COMPLETE” (S38). The state information 132 after the processing of S38 is executed will be described below.

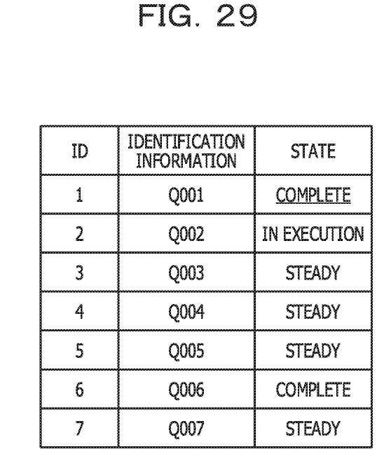

FIG. 29 is a table illustrating the state information 132 after the processing of S38 is executed. As indicated by an underlined part in FIG. 29, after the processing of S38 is executed, the state information management section 116 updates “STATE” of information (information that corresponds to the specific queue 31A transfer of management of which has been performed) “IDENTIFICATION INFORMATION” of which is “Q001” in the state information 132 to “COMPLETE”.

[Details of Message Addition Processing]

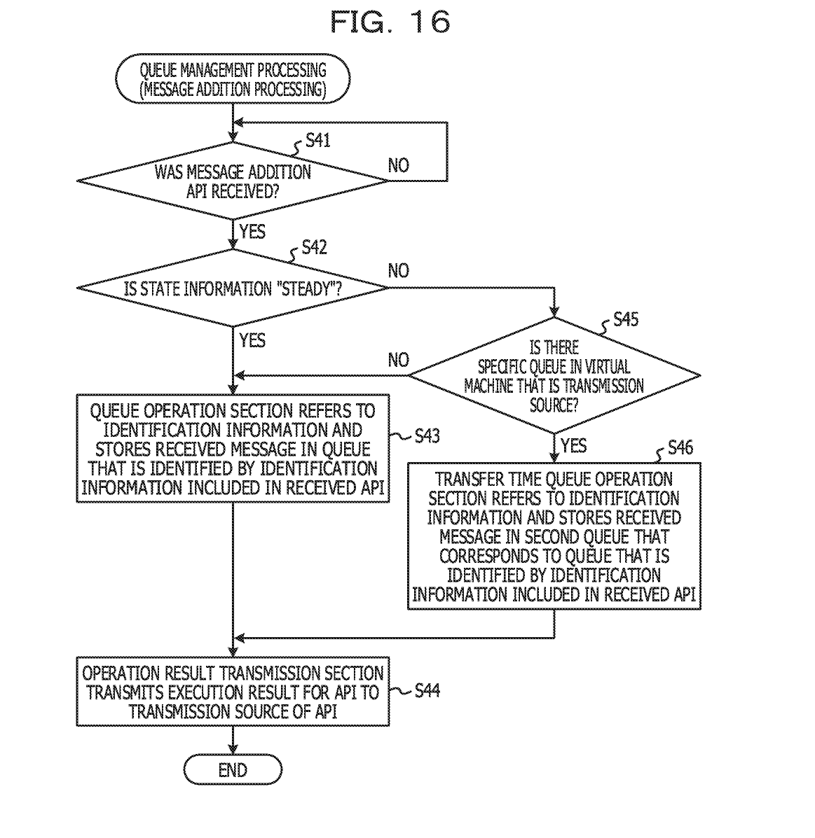

Next, details of message addition processing will be described. FIG. 16 is a flow chart illustrating details of message addition processing according to the first embodiment.

First, as illustrated in FIG. 16, the API reception section 111 of the information processing device 1 stands by until the API reception section 111 receives an API (which will be hereinafter also referred to as a message addition API) used for adding a message to a queue (NO in S41). Thereafter, if the API reception section 111 receives the message addition API (YES in S41), the queue operation section 112 refers to the state information 132 stored in the information storage area 130 (S42).

As a result, if “STATE” of a queue identified by the queue identification information 131 included in the received API indicates “STEADY” (YES in S42), the queue operation section 112 refers to the queue identification information 131 stored in the information storage area 130. Then, the queue operation section 112 stores a message included in the received API in a queue (a normal queue) that is identified by the queue identification information 131 included in the API received in S41 (S43).

That is, if the state information 132 is “STEADY”, in the information processing device 1, it is determined that message transfer is not being performed. Therefore, in this case, the queue operation section 112 stores a received message in the normal queue indicated by the queue identification information 131 included in the received API.

If “STATE” of a queue that corresponds to the received API indicates an item other than “STEADY” (NO in S42), the queue operation section 112 determines whether or not there is a queue that corresponds to the received API in the virtual machine 3 that is a transfer source (S45). As a result, if there is not a queue that corresponds to the received API in the virtual machine 3 that is a transfer source (NO in S45), the queue operation section 112 refers to the queue identification information 131 stored in the information storage area 130. Then, the queue operation section 112 stores the received message in the normal queue that is identified by the queue identification information 131 included in the API received in S41 (S43). If there is a queue that corresponds to the received API in the virtual machine 3 that is a transfer source (YES in S45), the transfer time queue operation section 114 refers to the queue identification information 131 that is stored in the information storage area 130. Then, the transfer time queue operation section 114 stores the received message in a new queue that corresponds to the normal queue that is identified by the queue identification information 131 included in the API received in S41 (S46).

That is, in processing of S45, if there is not a normal queue that corresponds to the received API in the virtual machine 3 that is a transfer source, it is indicated that, after message transfer from the normal queue to a temporary queue is completed, the normal queue has been already deleted (S36 in FIG. 15). In this case, a new queue that corresponds to the normal queue functions as a new normal queue, instead of the normal queue that has been deleted (S37 in FIG. 15). Therefore, in this case, the queue operation section 112 stores a message included in the received API in the normal queue that is identified by the queue identification information 131 included in the received API in a similar manner to that when queue management transfer is not performed.

On the other hand, in the processing of S45, if there is a normal queue that corresponds to the received API in the virtual machine 3 that is a transfer source, there is a probability that message transfer from the normal queue to a temporary queue is not completed. In this case, when the queue operation section 112 (the transfer time queue operation section 114) stores the received message in the normal queue, the processing order for messages stored in the normal queue may be possibly influenced. Therefore, in this case, the transfer time queue operation section 114 stores a message included in the received API in a new queue that corresponds to the normal queue that is identified by the queue identification information 131 included in the received API.

Thereafter, the operation result transmission section 113 of the information processing device 1 transmits an execution result for the message addition API received by the API reception section 111 to a transmission source (the user terminal 11) that has transmitted the message addition API (S44). Note that, if processing that corresponds to the message addition API received by the API reception section 111 fails, the operation result transmission section 113 may transmit a result indicating that the processing failed to the transmission source in processing of S44.

[Details of Message Reference Processing]

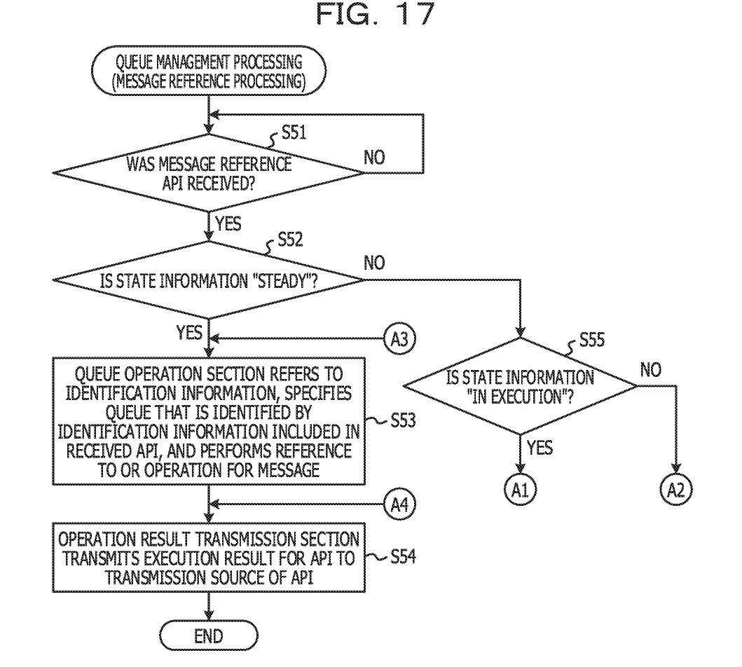

Next, details of message reference processing will be described. Each of FIG. 17 to FIG. 20 is a flow chart illustrating details of message reference processing according to the first embodiment.

First, as illustrated in FIG. 17, the API reception section 111 of the information processing device 1 stands by until the API reception section 111 receives an API (which will be hereinafter also referred to as a message reference API) used for performing reference to or an operation for a message stored in a queue (NO in S51). Thereafter, if the API reception section 111 receives the message reference API (YES in S51), the queue operation section 112 refers to the state information 132 stored in the information storage area 130 (S52).

[Processing that is Performed when “STATE” of Queue Indicates “STEADY”]

First, a case where “STATE” of a queue that is identified by the queue identification information 131 included in a received API indicates “STEADY” will be described. If “STATE” of a queue that is identified by the queue identification information 131 included in the received message indicates “STEADY” (YES in S52), the queue operation section 112 refers to the queue identification information 131 stored in the information storage area 130. Then, the queue operation section 112 specifies a queue (a normal queue) that is identified by the queue identification information 131 included in the API received in S51, and performs reference to or an operation for a message, based on contents of the message reference API (S53).

That is, if the state information 132 is “STEADY”, in the information processing device 1, it is determined that message transfer is not being performed. Therefore, the queue operation section 112 performs reference to or an operation for a message on the queue that is identified by the queue identification information 131 included in the API received in S51, based on the contents of the message reference API.

Thereafter, the operation result transmission section 113 of the information processing device 1 transmits an execution result for the message reference API received by the API reception section 111 to a transmission source (the user terminal 11) that has transmitted the message addition API (S54). Note that, if processing that corresponds to the message reference API received by the API reception section 111 fails, the operation result transmission section 113 may transmit a result indicating that the processing failed to the transmission source in processing of S54.

[Processing that is Performed when “STATE” of Queue Indicates “IN EXECUTION”]

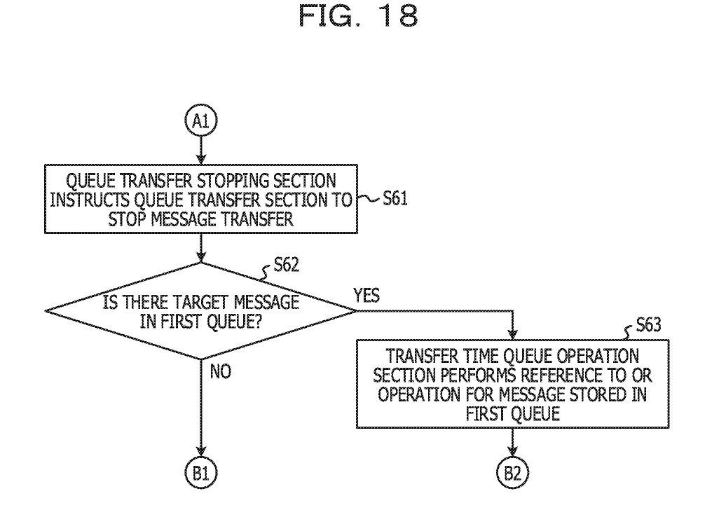

Next, a case where “STATE” of a queue that is identified by the queue identification information 131 included in the received API indicates “IN EXECUTION” will be described. If the state of a queue that corresponds to the received API indicates “IN EXECUTION” (NO in S52, YES in S55), as illustrated in FIG. 18, the queue transfer stopping section 117 of the information processing device 1 instructs the queue transfer section 115 to stop message transfer (S61).

That is, if the state of a queue that corresponds to the received API indicates “IN EXECUTION”, the queue transfer stopping section 117 determines that the queue that corresponds to the received API is the specific queue 31A (a normal queue transfer of management of which is performed by the queue transfer section 115). Therefore, in this case, the transfer time queue operation section 114 performs reference to or an operation for a message on all of the specific queue 31A, the first queue 33B, and the second queue 34B as targets.

In this case, if reference to or an operation for a message is performed by the transfer time queue operation section 114 simultaneously with message transfer performed by the queue transfer section 115, depending on a timing of message transfer, a message on which processing by the transfer time queue operation section 114 is not performed is generated. Specifically, when a message is transferred from a queue on which processing by the transfer time queue operation section 114 has not been performed yet to a queue on which processing has been already performed, a message on which processing by the transfer time queue operation section 114 is not performed is generated.

Then, when a message reference API is generated, the queue transfer stopping section 117 instructs the queue transfer section 115 to stop queue transfer. Thus, the queue transfer stopping section 117 may reduce generation of a message on which processing by the transfer time queue operation section 114 is not performed.

Thereafter, the transfer time queue operation section 114 determines whether or not there is a message (which will be hereinafter also referred to as a target message) that is a target on which reference or an operation is to be performed in the first queue 33B (S62). As a result, if there is a target message in the first queue 33B (YES in S62), the transfer time queue operation section 114 performs reference to or an operation for a message stored in the first queue 33B (S63).

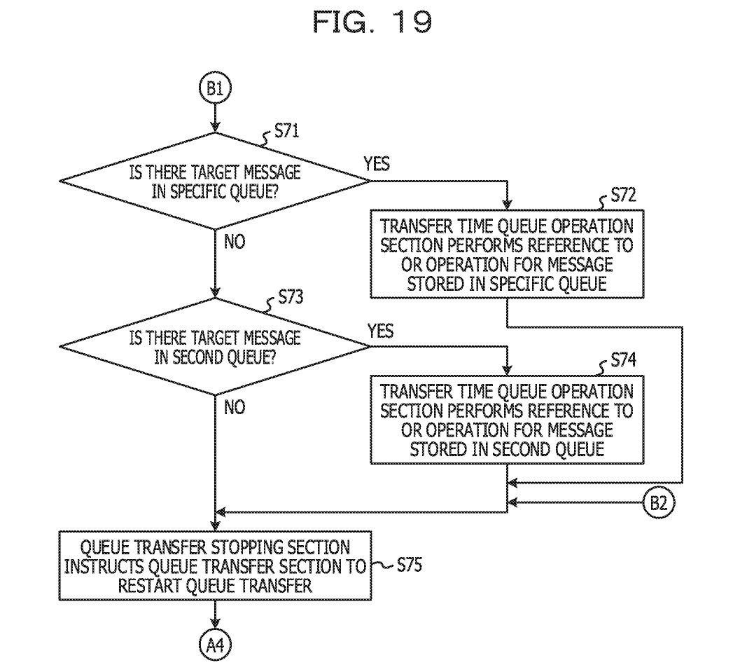

Next, if there is not a target message in the first queue 33B (NO in S62), as illustrated in FIG. 19, the transfer time queue operation section 114 determines whether or not there is a target message in the specific queue 31A (S71). As a result, if there is a target message in the specific queue 31A (YES in S71), the transfer time queue operation section 114 performs reference to or an operation for a message stored in the specific queue 31A (S72). On the other hand, if there is not a target message in the specific queue 31A (NO in S71), the transfer time queue operation section 114 does not perform reference to or an operation for a message stored in the specific queue 31A.

Subsequently, the transfer time queue operation section 114 determines whether or not there is a target message in the second queue 34B (S73). As a result, if there is a target message in the second queue 34B (YES in S73), the transfer time queue operation section 114 performs reference to or an operation for a message stored in the second queue 34B (S74). On the other hand, if there is not a target message in the second queue 34B (NO in S73), the transfer time queue operation section 114 does not perform reference to or an operation for a message stored in the second queue 34B.

That is, while queue management transfer is performed by the queue transfer section 115, a message stored in a first queue, a message stored in a specific queue, and a message stored in a second queue have a relationship in which the respective processing orders thereof are consecutive. Therefore, as illustrated in FIG. 18 and FIG. 19, the transfer time queue operation section 114 performs reference to or an operation for a message, based on contents of a message operation API, in the order of the first queue, the specific queue, and the second queue. Thus, the transfer time queue operation section 114 may reduce influences of message transfer on the processing order for messages and the like. Therefore, a user may perform reference to or an operation for a message in a similar manner to that when message transfer is not performed.

Then, when reference to or an operation for a message is performed (S63 in FIG. 18, S72 or S74 in FIG. 19), the queue transfer stopping section 117 instructs the queue transfer section 115 to restart queue management transfer (S75). Also, when reference to or an operation for a message fails (NO in S73), the queue transfer stopping section 117 instructs the queue transfer section 115 to restart queue management transfer in a similar manner (S75). Thereafter, the operation result transmission section 113 transmits an execution result for a message reference API received by the API reception section 111 to the transmission source (the user terminal 11) of the message reference API (S54 in FIG. 17).

[Processing that is Performed when “STATE” of Queue Indicates “COMPLETE”]

Next, a case where “STATE” of a queue that is identified by the queue identification information 131 included in a received API indicates “COMPLETE” will be described.

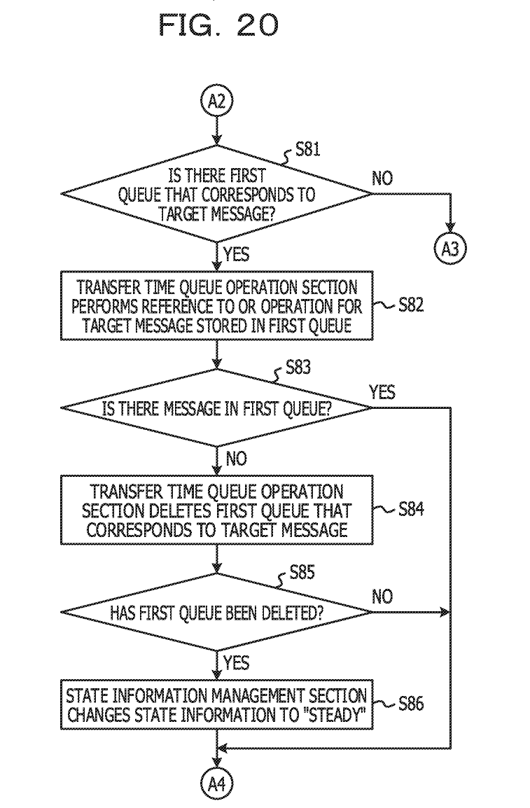

In this case, as illustrated in FIG. 20, the transfer time queue operation section 114 determines whether or not there is the first queue 33B that corresponds to a target message (S81). Then, if the transfer time queue operation section 114 determines that there is the first queue 33B (YES in S81), the transfer time queue operation section 114 performs reference to or an operation for the target message stored in the first queue 33B (S82).

That is, as will be described later, when there is no longer a message in the first queue 33B, the first queue 33B is deleted. Therefore, if there is the first queue 33B that corresponds to the target message (YES in S81), there is a message in the first queue 33B. Accordingly, if there is the first queue 33B that corresponds to the target message (YES in S81), the transfer time queue operation section 114 performs reference to or an operation for the target message stored in the first queue 33B (S82).

Note that, if the state of a queue that corresponds to the received API indicates “COMPLETE”, the specific queue 31A has been already deleted (S36 in FIG. 15), and the second queue 34B, instead of the specific queue 31A, functions as a normal queue. The second queue 34B that functions as a normal queue will be hereinafter also referred to as an already-transferred queue 34B.

On the other hand, if the transfer time queue operation section 114 determines that there is not the first queue 33B (NO in S81), the queue operation section 112 performs reference to or an operation for a message on a queue (the already-transferred queue 34B) that is identified by the queue identification information 131 included in the received API (S53, S54 in FIG. 17). That is, if the transfer time queue operation section 114 determines that there is not the first queue 33B, the specific queue 31A and the first queue 33B have been already deleted, and there is only the already-transferred queue 34B. Therefore, the queue operation section 112 performs reference to or an operation for a message in a similar manner to that when queue management transfer is not performed.

Thereafter, the transfer time queue operation section 114 determines whether or not there is a message in a first queue that corresponds to the target message (S83). Then, if the transfer time queue operation section 114 determines that there is not a message in a first queue that corresponds to the target message (NO in S83), the transfer time queue operation section 114 deletes the first queue that corresponds to the target message (S84). That is, in this case, the transfer time queue operation section 114 determines that all of messages stored in the first queue have been already executed by the virtual machine 3A, the transfer time queue operation section 114 deletes the first queue that corresponds to the target message.

On the other hand, if the transfer time queue operation section 114 determines that there is a message in a first queue that corresponds to the target message (YES in S83), the transfer time queue operation section 114 does not delete the first queue that corresponds to the target message. The queue identification information 131 after processing of S84 is executed will be described below.

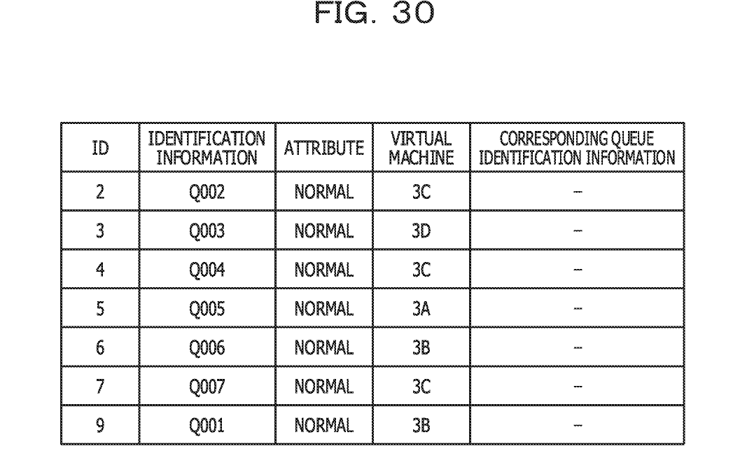

FIG. 30 is a table illustrating the queue identification information 131 after the processing of S84 is executed. As compared to the queue identification information 131 illustrated in FIG. 28, in the queue identification information 131 illustrated in FIG. 30, information “ID” of which is “8” has been deleted. Thus, the state information management section 116 may complete transfer of management of the specific queue 31A also in management of the state information 132.

Returning to FIG. 20, if the first queue 33B generated as message transfer was performed has been deleted (YES in S85), the state information management section 116 changes information that corresponds to a queue on which message transfer has been performed in the state information 132 stored in the information storage area 130 to “STEADY” (S86). That is, in this case, the state information management section 116 determines that transfer of management of the specific queue 31A is perfectly completed.

On the other hand, if all of the first queue generated as message transfer was performed have not been deleted (NO in S85), the state information management section 116 does not update information included in the state information 132 stored in the information storage area 130.

Then, the operation result transmission section 113 transmits an execution result for a message reference API received by the API reception section 111 to the transmission source (the user terminal 11) of the message reference API (S54 in FIG. 17).

[Processing that is Performed when API Reception Section Receives Queue Addition API]

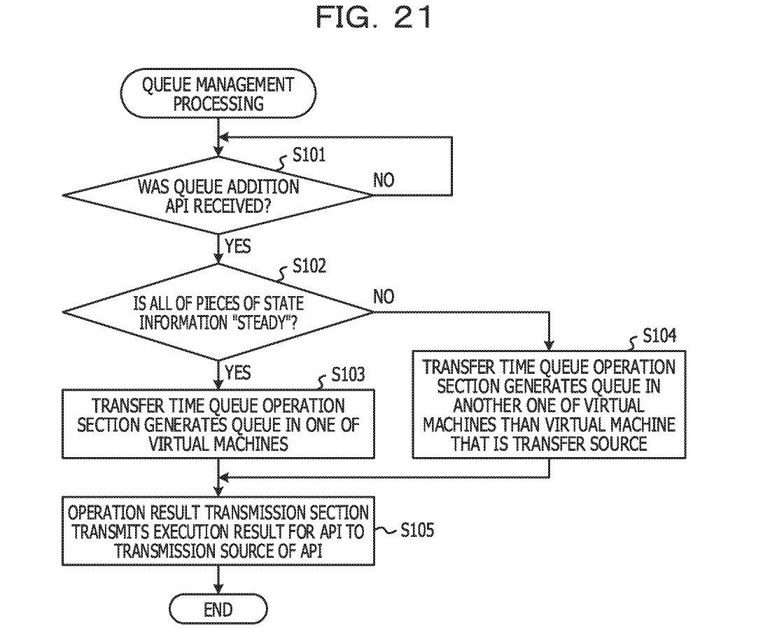

Next, processing (which will be hereinafter also referred to as queue addition processing) that is performed when the API reception section 111 receives an API (which will be hereinafter also referred to as a queue addition API) used for adding a queue will be described. FIG. 21 is a flow chart illustrating details of queue addition processing according to the first embodiment.

First, as illustrated in FIG. 21, the API reception section 111 stands by until the API reception section 111 receives a queue addition API (NO in S101). Thereafter, if the API reception section 111 receives a queue addition API (YES in S101), the queue operation section 112 refers to the state information 132 stored in the information storage area 130 (S102).

Then, if all of pieces of information set in “STATE” included in the state information 132 is “STEADY” (YES in S102), the transfer time queue operation section 114 generates a new queue in one of the virtual machines 3 (S103). On the other hand, if there is information that is not “STEADY”, among the pieces of information set in “STATE” included in the state information 132 (NO in S102), for example, the transfer time queue operation section 114 generates a new queue in another one of the virtual machines 3 than one of the virtual machines 3 in which a queue (the specific queue 31A) for which management transfer has been performed has been generated (S104).

That is, queue management transfer is performed when the load of the virtual machine 3 that is a transfer source exceeds a predetermined threshold, when the virtual machine 3 that is a transfer source is planned to be deleted, and the like. Therefore, the transfer time queue operation section 114 may be configured not to generate, when queue management transfer is performed, a new queue in the virtual machine 3 that is a transfer source.

Thereafter, the operation result transmission section 113 transmits an execution result for the queue addition API received by the API reception section 111 to the transmission source (the user terminal 11) that has transmitted the queue addition API (S105).

[Processing that is Performed when API Reception Section Receives Queue Deletion API]

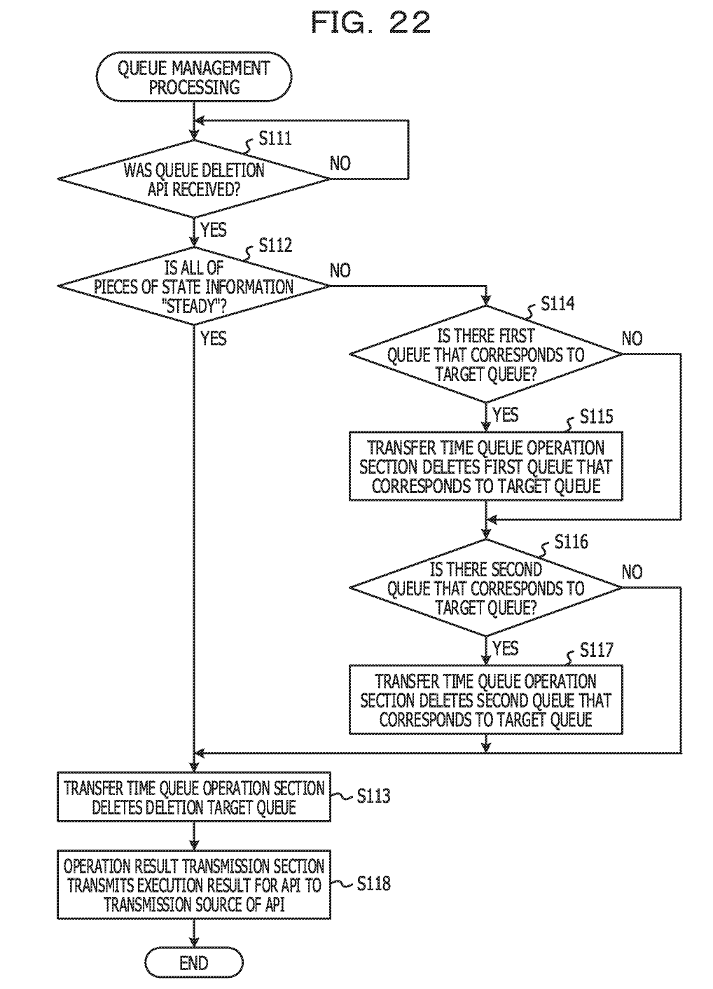

Next, processing (which will be hereinafter also referred to as queue deletion processing) that is performed when the API reception section 111 receives an API (which will be hereinafter also referred to as a queue deletion API) used for deleting a queue will be described. FIG. 22 is a flow chart illustrating details of queue deletion processing according to the first embodiment.

First, as illustrated in FIG. 22, the API reception section 111 stands by until the API reception section 111 receives a queue deletion API (NO in S111). Thereafter, if the API reception section 111 receives a queue deletion API (YES in S111), the queue operation section 112 refers to the state information 132 stored in the information storage area 130 (S112).

Then, if there is information that is not “STEADY”, among the pieces of information set in “STATE” included in the state information 132 (NO in S112), the transfer time queue operation section 114 determines whether or not there is a first queue that corresponds to a target queue (S114). As a result, if there is a first queue that corresponds to a target queue (YES in S114), the transfer time queue operation section 114 deletes the first queue (S115). On the other hand, if there is not a first queue that corresponds to a target queue (NO in S114), the transfer time queue operation section 114 does not perform processing of S115.

Furthermore, if there is information that is not “STEADY”, among the pieces of information set in “STATE” included in the state information 132 (NO in S112), the transfer time queue operation section 114 determines whether or not there is a second queue that corresponds to the target queue (S116). As a result, if there is a second queue that corresponds to the target queue (YES in S116), the transfer time queue operation section 114 deletes the second queue (S117). On the other hand, if there is not a second queue that corresponds to the target queue (NO in S116), the transfer time queue operation section 114 does not perform processing of S117.

Then, the transfer time queue operation section 114 deletes a deletion target queue (S113). Also, if all of pieces of information set in “STATE” included in the state information 132 is “STEADY”, the transfer time queue operation section 114 deletes the deletion target queue in a similar manner (YES in S112, S113). That is, if there is information that is not “STEADY”, among the pieces of information set in “STATE” included in the state information 132, message transfer is performed in one of queues. In this case, there is a probability that a first queue and a second queue that correspond to the deletion target queue have been generated. Therefore, the transfer time queue operation section 114 performs deletion of the first queue and the second queue, in addition to the deletion target queue.

Thereafter, the operation result transmission section 113 transmits an execution result for the queue deletion API received by the API reception section 111 to the transmission source (the user terminal 11) that has transmitted the queue deletion API (S118).

Thus, when the information processing device 1 transfers management of the specific queue 31A that is managed by the first virtual machine 3A and corresponds to the specific queue identification information 131 to the second virtual machine 3B, the information processing device 1 generates the first queue 33B and the second queue 34B in the second virtual machine 3B. Then, the information processing device 1 stores a specific message that has been stored in the specific queue 31A of the first virtual machine 3A in the first specific queue 33B from the head side of a queue, and stores a received message including the specific queue identification information 131 in the second queue 34B.

Thereafter, in accordance with an instruction to perform reference to or an operation for the specific message, the information processing device 1 performs reference to or an operation for the specific message in the order of the first queue 33B, the specific queue 31A, and the second queue 34B.

Thus, the information processing device 1 may perform transfer of management of the specific queue 31A without stopping services provided using the message queue system 10.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A queue management method comprising:
queuing, in a specific queue of a first virtual machine, one or more messages addressed to the specific queue;
generating, when transferring management of the specific queue from the first virtual machine to a second virtual machine, a first queue and a second queue in the second virtual machine;
queuing, in the generated first queue, the one or more messages that have been queued in the specific queue before generating the first queue;
queuing, after the second queue has been generated, a received message addressed to the specific queue in the second queue; and
performing, in response to an instruction to perform reference to or an operation for a specific message corresponding to the specific queue, reference to or an operation for the specific message in order of the first queue, the specific queue, and the second queue.

2. The queue management method according to claim 1, wherein
the one or more messages are queued in the first queue from a head side of the specific queue.

3. The queue management method according to claim 1, further comprising:
deleting the specific queue after the queuing for the one or more messages from the specific queue to the first queue has finished; and
performing, after the deleting, reference to or an operation for the message corresponding to the specific in order of the first queue and the second queue.

4. The queue management method according to claim 1, wherein
in the performing reference to or an operation for the specific message, when transfer of the specific message to the first queue has not completed, the queuing of the specific message to the first queue is suppressed.

5. The queue management method according to claim 1, wherein
in accordance with an instruction to generate a new queue, a new queue is generated in another one of the plurality of virtual machines than the first virtual machine.

6. The queue management method according to claim 1, wherein
in accordance with an instruction to delete the specific queue, the specific queue, the first queue, and the second queue are deleted.

7. A non-transitory computer-readable recording medium storing a queue management program that causes a computer to execute a process comprising:
queuing, in a specific queue of a first virtual machine, one or more messages addressed to the specific queue;
generating, when transferring management of the specific queue from the first virtual machine to a second virtual machine, a first queue and a second queue in the second virtual machine;
queuing, in the generated first queue, the one or more messages that have been queued in the specific queue before generating the first queue;
queuing, after the second queue has been generated, a received message addressed to the specific queue in the second queue; and
performing, in response to an instruction to perform reference to or an operation for a specific message corresponding to the specific queue, reference to or an operation for the specific message in order of the first queue, the specific queue, and the second queue.

8. A queue management device comprising:
a memory; and
a processor coupled to the memory, the processor configured to:
queue, in a specific queue of a first virtual machine, one or more messages addressed to the specific queue;
generate, when transferring management of the specific queue from the first virtual machine to a second virtual machine, a first queue and a second queue in the second virtual machine;
queue, in the generated first queue, the one or more messages that have been queued in the specific queue before generating the first queue;
queue, after the second queue has been generated, a received message addressed to the specific queue in the second queue; and
perform, in response to an instruction to perform reference to or an operation for a specific message corresponding to the specific queue, reference to or an operation for the specific message in order of the first queue, the specific queue, and the second queue.
